(19) United States
(12) Patent Application Publication
(10) Pub. No.: US 2005/0223160 A1
(43) Pub. Date: Oct. 6, 2005

(54) Memory controller

(76) Inventors: Kazunari Sesumi, Tokyo (JP); Kenji Asai, Tokyo (JP)

Correspondence Address: RABIN & BERDO, P.C., Suite 500, 1101 14th Street, Washington, DC, 20005, US

(21) Appl. No.: 11/079,210

(22) Filed: Mar. 15, 2005

(30) Foreign Application Priority Data
Apr. 5, 2004 (JP) 2004-111091

(51) Int. Cl. G06F 12/00

(52) U.S. Cl. 711/105; 711/167

(57) ABSTRACT

A memory controller which can freely set parameters without a significant increase in circuit scale. Selection information and addition information applied from a CPU as a data signal are held in a register. The selection information is commonly applied to a plurality of selectors as a selection signal, while the addition information is commonly applied to a plurality of adders as an addition value VA. Each of the selectors selects one from a plurality of input data in accordance with the select signal. The addition value is added to data output from the respective selectors in adders associated therewith, and the state machine is applied with the values of the addition results as parameters, i.e., an address setup value, an assert pulse width, and a data off value, respectively.

### BACKGROUND OF THE INVENTION

1. Field of the Invention

The present invention relates to a general-purpose memory controller for controlling timings for read and write operations between a central processing unit (CPU) and a storage device such as SRAM (Static Random Access Memory), ROM (Read Only Memory) or the like, and more particularly, to settings of access parameters of the memory controller.

2. Description of the Related Art

FIG. 1 is a block diagram showing the configuration of a conventional memory controller. As shown in FIG. 1, the memory controller 10 controls timings for read and write operations between a CPU 1 and a memory such as an SRAM 2, which differ in operation timing from each other. In addition to a state machine 11 which is a main component, the memory controller 10 comprises a decoder 12, a register 13, and selectors 14-16.

The state machine 11 is a logical circuit which transitions to a next predefined state corresponding to a currently held state and a given signal (event). The CPU 1 applies the state machine 11 with a chip select signal CS1, which is generated by decoding an upper address ADU by the decoder 12, in addition to a read/write control signal RW and a lower address ADL within an address signal AD. The state machine 11 supplies the SRAM 2 with a read/write control signal MRW, the timing of which is controlled in accordance with the characteristics of the SRAM 2, a chip select signal MCS, and an address signal MAD. A data signal DT input to and output from the CPU 1 has timings controlled by the state machine 11, and is input to and output from the SRAM 2 as a data signal MDT. Operation timings of the state machine 11 are controlled by a clock signal CK which is common to the CPU 1.

The decoder 12 decodes the upper address ADU to output a chip select signal CS1, and also outputs a chip select signal CS2 corresponding to a register 13 within the memory controller 10. The register 13 stores a data signal DT output from the CPU 1 in accordance with a timing of the clock signal CK when the chip select signal CS2 is selected and a write is specified by the read/write control signal RW. The contents stored in the register 13 are applied to the selectors 14-16 as a select signal SL.

Each of the selectors 14-16 selects data specified by the select signal SL from among four input data, and applies the selected data to the state machine 11. For example, the selector 14 applies data “1” to the state machine 11 as an address setup value ASU when the select signal SL is “0” or “1,” and applies data “2” to the state machine 11 as the address setup value ASU when the select signal SL is “2” or “3.” The selector 15 applies data “1,” “2,” “3,” “5” to the state machine 11 as an assert pulse width APW corresponding to “0,” “1,” “2,” “3” of the select signal SL, respectively. Further, the selector 16 applies data “1,” “2,” “3,” “3” to the state machine 11 as a data off value DOF corresponding to “0,” “1,” “2,” “3” of the select signal SL, respectively.

Next, the operation will be described with reference to FIG. 2.

During an initial setting at power-on, CPU 1 reads the type and the like of the SRAM 2, and writes selection information for selecting a combination of the address setup value ASU, assert pulse width APW, and data off value DOF in accordance with the SRAM 2 into the register 13. Assume herein that “1” is written into the register 13. This causes the selector 14 to select input data “1” which is applied to the state machine 11 as the address setup value ASU. The selector 15 selects input data “2” which is applied to the state machine 11 as the assert pulse width APW. Further, the selector 16 selects input data “2” which is applied to the state machine 11 as the data off value DOF.

Next, the CPU 1 starts an access to the SRAM 2, controls the timing based on the foregoing address setup value ASU, assert pulse width APW, and data off value DOF to execute an access to the SRAM 2 for a read or a write.

At a rising edge of the clock signal CK at time T1 in FIG. 2, the CPU 1 outputs an address signal DA for specifying the SRAM 2, and the read/write control signal RW. The upper address ADU of the address signal AD is decoded by the decoder 12, and a chip select signal CS1 is applied to the state machine 11. The lower address ADL and read/write control signal RW are applied to the state machine 11 as they are.

At the next rising edge of the clock signal CK at time T2, the state machine 11 outputs a chip select signal MCS to the SRAM 2. Also, the CPU 1 starts outputting a data signal DT, while the address signal AD and read/write control signal RW, which have been output from the CPU 1, are stopped at this instant.

After the lapse of one clock period specified by the address setup value ASU from time T2, the state machine 11 outputs an address signal MAD to the SRAM 2 at a rising edge of the clock signal CK at time T3.

At the next rising edge of the clock signal CK at time T4, the state machine 11 outputs a data signal MDT to the SRAM 2 to start a data transfer between the CPU 1 and the SRAM 2.

After the lapse of two clock periods specified by the assert pulse width APW from time T3, the chip select signal MCS and read/write control signal MRW, which have been output from the state machine 11, are stopped at a rising edge of the clock signal CK at time T5.

Further, after the lapse of two clock periods specified by the data off value DOF from time T5, the data signal MDT, which has been output from the state machine 11, is stopped at a rising edge of the clock signal CK at time T6. Thus, an access to the address MAD in the SRAM 2 is completed.

Japanese Patent Kokai No. 5-128838 (Patent Document 1) and Japanese Patent Kokai No. 11-219314 (Patent Document 2) are known.

However, the memory controller 10 is limited in available combinations of the address setup value ASU, assert pulse value APW, and data off value DOF. Specifically, there are only four possible combinations which can be selected: (ASU=1, APW=1, DOF=1) when the select signal SL=0; (ASU=1, APW=2, DOF=2) when the select signal SL=1; (ASU=2, APW=3, DOF=3) when the select signal SL=2; (ASU2, APS=5, DOF=3) when the select signal SL=3. In addition, the parameters are available only in fixed combinations. Moreover, for expanding a selectable range, the selectors 14-16 must be applied with a significantly increased number of data, resulting in a problem of an increase in circuit scale.

### SUMMARY OF THE INVENTION

It is an object of the present invention to provide a memory controller which is capable of freely setting parameters while limiting an increase in circuit scale.

The memory controller of the present invention includes a state machine for controlling timings for a control signal, an address signal, and a data signal transferred between a CPU and a storage device in accordance with parameters applied thereto, a register for holding selection information and addition information applied by the CPU, a selector for selecting appropriate data from a plurality of data in accordance with the selection information, and an adder for adding the addition information to the data selected by the selector and applying the state machine with the addition result as the parameter.

According to the present invention, appropriate data is selected by the selector from a plurality of data in accordance with the selection information, and the addition information is added to the data selected by the selector to apply the state machine with the addition result as the parameter. In this way, the present invention is advantageous in that the parameters applied to the state machine can be set over an expanded range without largely increasing-the circuit scale.

### BRIEF DESCRIPTION OF THE DRAWINGS

FIG. 1 is a block diagram showing the configuration of a conventional memory controller;

FIG. 2 is a timing chart showing the operation of the conventional memory controller;

FIG. 3 is a block diagram showing the configuration of a memory controller according to a first embodiment of the present invention; and

FIG. 4 is a block diagram showing the configuration of a memory controller according to a second embodiment of the present invention.

### DETAILED DESCRIPTION OF THE INVENTION

For a state machine which controls timings for a control signal, an address signal, and a data signal transferred between a CPU and a storage device in accordance with three parameters including an address setup value, an assert pulse value, and a data off value, three selectors provided corresponding to the respective parameters select appropriate data from among a plurality of data based on first selection information, respectively. Then, addition information is added to data selected by one of the three selectors which is associated with second selection information, and the resulting sum is applied to the state machine as a parameter, while data selected by selectors which are not associated with the second selection information are applied as they are to the state machine as parameters.

The above and other objects and novel features of the present invention will become more fully apparent from the following description of preferred embodiments, when read with reference to the accompanying drawings. The drawings, however, are provided only for purposes of description, and are not at all intended to limit the scope of the invention.

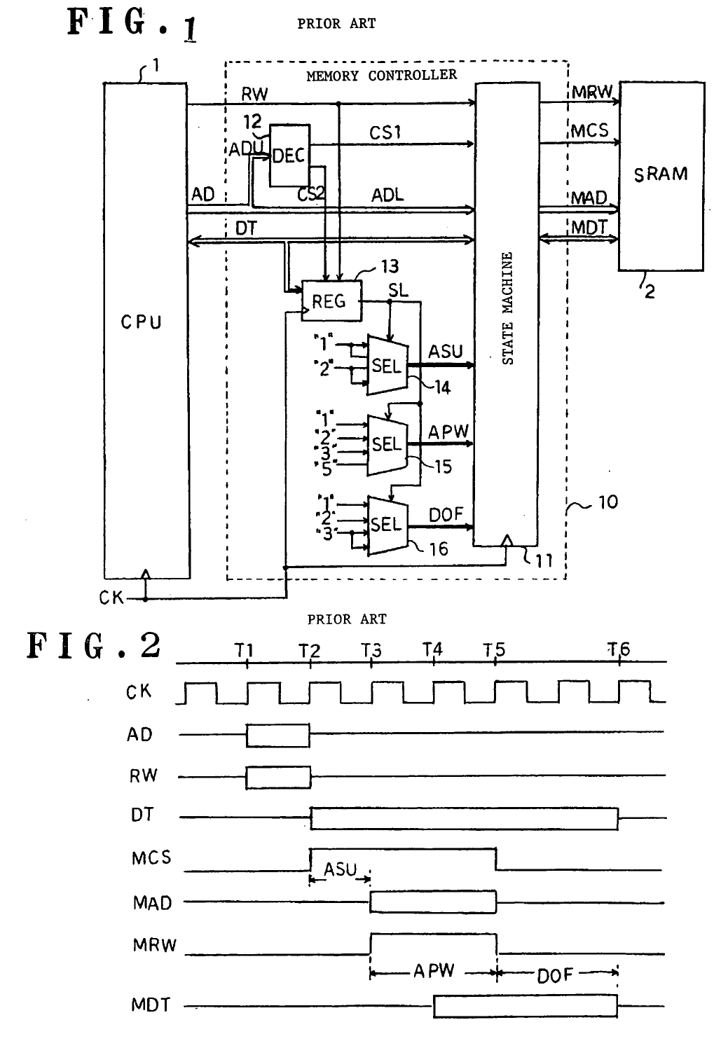

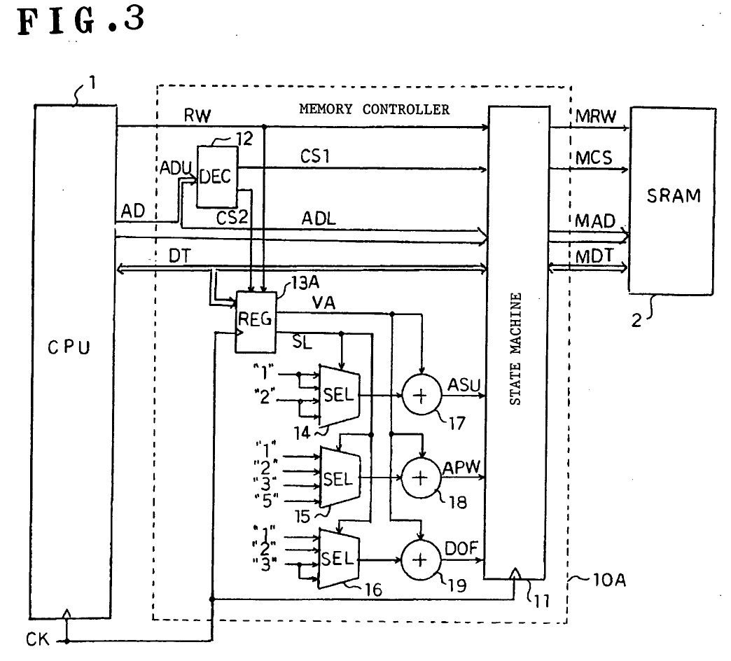

FIG. 3 is a diagram showing the configuration of a memory controller according to a first embodiment of the present invention, wherein components common to those in FIG. 1 are designated the same reference numerals.

The memory controller 10A controls timings for read and write operations between a CPU 1 and a storage device such as an SRAM 2, a ROM and the like, which differ in operation timing from each other, and comprises a decoder 12, a register 13A, selectors 14-16, and adders 17-19, in addition to a state machine 11 which is a main component thereof.

The state machine 11 is a logic circuit which transitions to a predefined next state in accordance with given parameters, corresponding to a currently held state and a signal applied thereto. The CPU 1 applies the state machine 11 with a chip select signal CS1 which is generated by decoding an upper address ADU by the decoder 12, in addition to control signals such as a read/write control signal RW, and a lower address ADL in an address signal AD.

The state machine 11 applies the SRAM 2 with a read/write control signal MRW, the timing of which is controlled in accordance with the characteristics of the SRAM 2, a chip select signal MCS, and an address signal MAD. A data signal DT input to and output from the CPU 1 has a timing controlled by the state machine 11, and is input to and output from the SRAM 2 as a data signal MDT. The operation timing of the state machine 11 is controlled by a clock signal CK which is common to the CPU 1.

The decoder 12 decodes the upper address ADU to output a chip select signal CS1 corresponding to the SRAM 2, and also outputs a chip select signal CS2 corresponding to the register 13A within the memory controller 10.

The register 13A stores a data signal DT output from the CPU 1 in accordance with the timing of the clock signal CK when it is selected by the chip select signal CS2 and a write is specified by the read/write control signal RW. The register 13A is configured to store, for example, 2-bit selection information applied from the CPU 1 as the data signal, and 2-bit addition information. The selection information stored in the register 13A is applied to the selectors 14-16 as a selection signal SL, while the addition information is applied to the adders 17-19 as an addition value VA.

Each of the selectors 14-16 selects data specified by the select signal SL from among four input data, and applies the selected data to the associated adder 17-19, respectively. For example, the selector 14 selects data “1” when the select signal SL is “0” or “1,” and selects data “2” when the select signal is “2” or “3”, and applies the selected data to the adder 17. The selector 15 selects data “1,” “2,” “3,” “5” corresponding to “0,” “1,” “2,” “3” of the select signal SL, respectively, and applies the selected data to the adder 18. Further, the selector 16 selects data “1,” “2,” “3,” “3” corresponding to “0,” “1,” “2,” “3” of the select signal SL, respectively, and applies the selected data to the adder 19.

Each of the adders 17-19 adds the data applied from the associated selector 14-16 and the addition value VA commonly applied thereto from the register 13A, and applies the state machine 11 with the addition result as a parameter which is an address setup value ASU, an assert pulse width APW, or a data off value DOF.

The address setup value ASU is a parameter for setting the number of clocks from the generation of the chip select signal MCS to the SRAM 2 to the output of the established address signal MAD for specifying a storage area of the SRAM 2. The assert pulse width APW is a parameter for setting the number of clocks for a period in which the address signal MAD is output. The data off value DOF is a parameter for setting the number of clocks from the time at which the output of the address signal MAD is stopped to the time at which the data signal MDT for the SRAM 2 is stopped on a data bus.

Next, the operation will be described.

During an initial setting at power-on, the CPU 1 reads the type and the like of the SRAM 2. Then, the CPU 1 writes into the register 13 data for setting the parameters in accordance with this particular SRAM 2, including the address setup value ASU, assert pulse width APW, and data off value DOF. Assume herein that “1” is written into the register 13A as the selection information, and “2” is written into the register 13A as the addition information. Thus, the select signal SL output from the register 13A causes the selector 14 to select input data “1,” to which “2” is added in accordance with the addition value VA by the adder 17, so that “3” is applied to the state machine 11 as the address setup value ASU. The selector 15 selects input data “2” to which “2” is added by the adder 18, so that “4” is applied to the state machine 11 as the assert pulse width APW. Further, the selector 16 selects input data “2” to which “2” is added by the adder 19, so that “4” is applied to the state machine 11 as the data off value DOF.

Next, the CPU 1 starts an access to the SRAM 2, and controls the timing based on the address setup value ASU, assert pulse width APW, and data off value DOF to execute an access to the SRAM 2 for a read or a write. Since the state machine 11 is identical to that shown in FIG. 1, the state machine 11 operates in the manner described above except that different values are set to the parameters, i.e., the address setup value ASU, assert pulse width APW, and data off value DOF.

As described above, the memory controller according to the first embodiment comprises the adders 17-19 which add the common addition value VA to values selected by the selectors 14-16 to generate the address setup value ASU, assert pulse value APW, and data off value DOF, respectively. In this way, the memory controller can advantageously expand a range for the parameters in a simple circuit configuration.

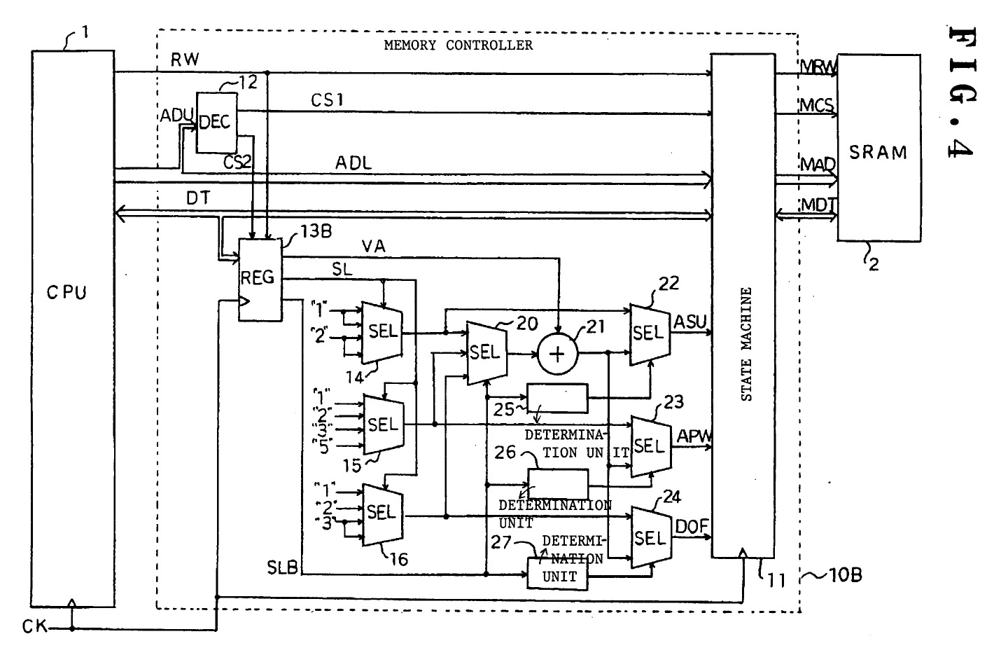

FIG. 4 shows the configuration of a memory controller according to a second embodiment of the present invention, wherein components common to those in FIG. 3 are designated the same reference numerals.

The memory controller 10B comprises a decoder 12, a register 13B, selectors 14-16, 20, 22-24, an adder 21, and determination units 25-27, in addition to a state machine 11 which is a main component thereof. Among these components, the state machine 11, decoder 12, and selectors 14-17 are identical to those in FIG. 3.

The register 13B stores a data signal DT in accordance with the timing of a clock signal CK when it is selected by a chip select signal CS2 and a write is specified by a read/write control signal RW. The register 13B is configured to hold, for example, first and second 2-bit selection information and 3-bit addition information, applied from the CPU 1 as a data signal DDT. The first selection information held in the register 13B is applied to the selectors 14-16 as a select signal SL; the second selection information is applied to the selector 20 as a select signal SLB; and the addition information is applied to the adder 21 as an addition value VA.

The outputs of the selectors 14-16 are connected to a parameter changing means which is composed of the selectors 20, 22-24, adder 21, and determination units 25-27. The parameter changing means adds the addition information held in the register 13B to data selected by one of the selectors 14-16 which is associated with the selection signal SLB, and applies the addition result to the state machine 11 as a parameter, and applies data selected by selectors which are not associated with the select signal SLB, as they are, to the state machine 11 as parameters.

Specifically, the output of the selector 14 is connected to a first input terminal of the selector 20 and to a first input terminal of the selector 22. The output of the selector 15 is connected to a second input terminal of the selector 20 and to a first input terminal of the selector 23. The output of the selector 16 is connected to a third input terminal of the selector 20 and to a first input terminal of the selector 24. The selector 20 selects the first to third input terminals for output respectively in accordance with the values “1,” “2,” “3” applied from the register 13B. An output signal of the selector 20 is applied to the adder 21.

The adder 21 adds the data applied from the selector 20 and the addition value VA applied from the register 13B, and applies the addition result commonly to respective second input terminals of the selectors 22-24. The determination unit 25 applies a determination signal to the selector 22 when the value of the select signal SLB is “1”; the determination unit 26 applies a determination signal to the selector 23 when the value of the select signal SLB is “2”; and the determination unit 27 applies a determination signal to the selector 24 when the value of the select signal SLB is “3.” The selectors 22-24 each select the first input terminal when they are not applied with the determination signal, and select the second input terminal selectors 22-24 apply the state machine 11 with the parameters, i.e., the address setup value ASU, assert pulse width APW, and data off value DOF, respectively.

Next, the operation will be described.

During an initial setting at power-on, the CPU 1 reads the type and the like of the SRAM 2, and writes into the register 13B the first and second selection information and delay information for selecting a combination of the address setup value ASU, assert pulse width APW, and data off value DOF in accordance with this particular SRAM 2. Assume herein that “1” is written into the register 13B as the first selection information, i.e, the select signal SL; “2” is written as the addition information, i.e., the addition value VA; and “3” is written as the second selection information, i.e., the select signal SLB.

Since the select signal SL is “1,” the selector 14 selects input data “1”; the selector 15 selects input data “2”; and the selector 16 selects input data “2.”

On the other hand, since the select signal SLB is “3,” the selector 20 selects an output signal of the selector 16, and applies the adder 21 with the selected output signal. The adder 21 adds the addition value VA (=“3”) output from the register 13B to the data “2” output from the selector 16, so that data “5,” which is the result of the addition, is applied to the respective second terminals of the selectors 22-24.

Further, since the select signal SLB is “3”, the

Further, since the select signal SLB is “3”, the determination unit 27 outputs a determination signal, whereas the determination units 25, 26 do not output a determination signal. This causes the selector 22 to select the data “1” output from the selector 14, which is applied to the state machine 11 as the address setup value ASU. The selector 23 selects the data “2” output from the selector 15, which is applied to the state machine 11 as the assert pulse width APW. Also, the selector 24 selects the data “5” output from the adder 21, which is applied to the state machine 11 as the data off value DOF.

Next, the CPU 1 starts an access to the SRAM 2, and controls the timing based on these address setup value ASU, assert pulse value APW, and data off value DOF to execute an access to the SRAM for a read or a write. Since the state machine 11 is identical to that shown in FIG. 1, the state machine 11 operates in the manner described above except that different values are set to the parameters, i.e., the address setup value ASU, assert pulse width APW, and data off value DOF.

As described above, the memory controller according to the second embodiment has the selector 20 for selecting one of data selected by the selectors 14-16; the adder 21 for adding the addition value VA to the output data of the selector 20; and the selectors 22-24 and determination units 25-27 for replacing the data selected by the selector 20 with the addition result of the adder 21 to output the address setup value ASU, assert pulse width APW, and data off value DOF. Advantageously, with this configuration, the memory controller can freely set the parameters.

The parameter changing means for adding the addition value VA to one of the address setup value ASU, assert pulse width APW, and data off value DOF selected by the selectors 14-16 in response to the select signal SL, changing the parameter to the addition result, and applying the state machine 11 with the changed parameter is not limited in circuit configuration to that illustrated in FIG. 4.

This application is based on Japanese Patent Application No. 2004-111091 which is herein incorporated by reference.

1. A memory controller comprising:
a state machine for controlling timings of a control signal, an address signal, and a data signal transferred between a central processing unit and a storage device in accordance with a parameter applied thereto;
a register for holding selection information and addition information applied from said central processing unit;
a selector for selecting appropriate data from a plurality of data in accordance with the selection information; and
an adder for adding the addition information to the data selected by said selector and applying said state machine with the addition result as the parameter.

2. A memory controller comprising:
a state machine for controlling timings of a control signal, an address signal, and a data signal transferred between a central processing unit and a storage device in accordance with a parameter applied thereto;
a register for holding first and second selection information and addition information applied from said central processing unit;
a plurality of selectors provided in correspondence to the plurality of parameters, each for selecting appropriate data from a plurality of data in accordance with the first selection information; and
parameter changing means for adding the addition information to data selected by a selector of said plurality of selectors which is associated with the second selection information to apply said state machine with the addition result as the parameter, and for applying said state machine with data selected by a selector which is not associated with the second selection information as it is.

3. A memory controller according to claim 1, wherein said parameters include:
an address setup value for setting the number of clocks from a time at which a chip select signal is output to said storage device to a time at which an established memory address is output for specifying a storage area in said storage device;
an assert pulse width for setting the number of clocks for a period in which the memory address is output; and
a data off value for setting the number of clocks from a time at which the output of the memory address is stopped to a time at which a data signal is stopped on a data bus to said memory.

4. A memory controller according to claim 2, wherein said parameters include:
an address setup value for setting the number of clocks from a time at which a chip select signal is output to said storage device to a time at which an established memory address is output for specifying a storage area in said storage device;
an assert pulse width for setting the number of clocks for a period in which the memory address is output; and
a data off value for setting the number of clocks from a time at which the output of the memory address is stopped to a time at which a data signal is stopped on a data bus to said memory.
